(19) United States
(12) Patent Application Publication
(10) Pub. No.: US 2017/0254101 A1
(43) Pub. Date: Sep. 7, 2017

(54) ARTICULATED BOOM

(71) Applicant: SCHWING GmbH, Herne (DE)

(72) Inventors: Bernd Segschneider, Dortmund (DE); Christoph Sacken, Haltern (DE)

(73) Assignee: SCHWING GmbH, Herne (DE)

(21) Appl. No.: 15/507,094

(22) PCT Filed: Aug. 25, 2015
(86) PCT No.: PCT/EP2015/069387

§ 371 Date: Feb. 27, 2017

(30) Foreign Application Priority Data
Aug. 27, 2014 (DE) 10 2014 012 493.2

(51) Int. Cl. E04G 21/04; B66C 23/68

(52) U.S. Cl. CPC E04G 21/0445; B66C 23/68

(57) ABSTRACT

An articulated boom includes a plurality of boom segments connected together via articulated joints. At least one of the boom segments includes a welded structure providing a box profile in which an upper flange and a lower flange are connected together by lateral web plates. At least one of the web plates, the upper flange, and the lower flange includes at least one reinforcing distortion.

The invention relates to an articulated boom and to a method for producing a boom segment of an articulated boom.

A plurality of designs of articulated booms, in particular for concrete pumps and other types of large manipulators, are disclosed in the prior art (see, for example, DE 196 44 410 A1). By larger and larger buildings being constructed, the demands on the boom lengths increase, i.e, on the reach of the pivotable articulated booms. In order to keep the inherent weight of the boom segments and consequently also of the articulated booms overall as low as possible, the known boom segments are realized from hollow profiles. Said hollow profiles are welded structures in which an upper flange and a lower flange are connected is together by means of lateral web plates. The boom segments can also be realized as a U-shaped profile, at least in part regions, e.g. at points where a hydraulic cylinder enters into the boom segment. If plates are subjected to pressure or shear stresses, they are then prone, where the buckling field is a corresponding size, to evade the load, i.e. they buckle. In order to be able to ensure the boom segments are sufficiently stable, the boom segments are designed such that the plates are not subjected to their maximum permitted stress. Over-sizing is the result, with the mass of the boom segments consequently being undesirably high.

In order to make the boom segments more resistant to buckling, i.e. to increase the rigidity of the boom segments, it is known from the prior art to weld reinforcements or webs to the plates. A disadvantage in this connection, however, is that the additional components result in an increase in the weight of the boom segments, which, in turn, has a negative effect on the stability and the length of the following segments of the articulated booms. In addition, such designs can result in welding distortions and the operating safety can be impaired as notches are frequently formed in highly loaded zones. For this reason, such reinforcements are only, as a rule, welded onto the web plates because they can comprise regions which are not subjected to maximum stress (neutral fibers). Said regions are not present, however, in the upper and lower flanges as, in their case, the same stress is present over the entire region.

It is consequently an object of the invention to provide an articulated boom which can be produced in a simple and cost-efficient manner whilst having improved mechanical characteristics and a reduction in weight.

Said object is achieved by an articulated boom with the features of claim 1 as well as by a method for producing a boom segment of an articulated boom with the features of claim 11.

Advantageous developments are in each case the object of the dependent claims. It must be pointed out that the features stated individually in the claims can also be combined together in an arbitrary and technologically sensible manner and consequently demonstrate further designs of the invention.

The articulated boom according to the invention comprises a plurality of boom segments which are connected together via articulated joints, wherein at least one of the boom segments comprises a welded structure which is realized as a box profile and in which an upper flange and a lower flange are connected together by means of lateral web plates. The articulated boom is characterized in that at least one of the web plates, the upper flange and/or the lower flange comprise(s) at least one reinforcing distortion.

The web plates, the upper flange and the lower flange are combined below under the designation of plate. If, consequently, plate is mentioned below, this then refers to both the web plates, the upper flange and the lower flange.

The plate according to the invention is reinforced in a weight-saving manner. Due to the bevel radii, the reinforcement spans a large region and thus reduces the buckling field in a considerable manner. As a result of the reinforcement, the weight of the articulated boom is reduced, as additional reinforcements by means of welded-on webs, as is usual in the prior art, can be omitted. Consequently, it is possible to produce articulated booms which comprise a greater length than the known articulated booms. The articulated boom according to the invention also comprises the advantage, compared to the prior art, of the welded seams/notches being omitted as a result of reforming, e.g. as a result of beveling or rolling, the plate, and consequently of the operational stability of the structure being able to be increased. As a result of omitting the welded-on webs, the articulated boom can also be produced in a considerably simpler and quicker manner, which has a favorable effect on the production costs. In addition, less material is required for the articulated boom according to is the invention. All in all, it is thus possible to provide a weight-optimized and long-lasting articulated boom which can also be produced in a cost-efficient and simple manner.

In an advantageous manner, the reinforcing deformation is a channel-like indentation of the plate which extends substantially parallel to the longitudinal axis of the boom segment. Accordingly, the reinforcing deformation extends in the direction of the main load of the plates, as a result of which the operational stability can be improved in a considerable manner. Said channel-like indentation can point inward or outward in the finished boom segment.

The reinforcing deformation is ideally a corrugation. In order to reinforce the boom segment in an optimum manner and consequently to satisfy the increasing demands on the articulated booms, the corrugation can comprise various designs. In particular, the effectiveness of the corrugation can be influenced as a result of it comprising various forms, developments and/or radii. The corrugation can be realized as a semicircular corrugation, a box corrugation, a trapezoidal corrugation or a triangular corrugation. The corrugation can additionally comprise an irregular development. The reinforcing effect can be improved as a result. It is also advantageous when the indentation forming the corrugation is realized in as deep a manner as possible. Large-surface corrugations, which, according to the invention, refer to corrugations where the width is greater in proportion to the depth, are to be preferred.

In addition, the effectiveness of the corrugation can be optimized as a result of the placer position of the corrugation on the plate, as a result of which even longer boom segments are able to be produced. The corrugation divides the plate in a preferred manner at the ratio of between 1:5 and 1:1 when viewed in the direction transversely with respect to the longitudinal axis of the boom segment. As a result, the corrugation can be adapted individually to the stresses that occur.

It is also conceivable for the plate to comprise more than one corrugation and these can extend parallel to one another; however, other optimized development forms of the corrugations are also conceivable such that they do not extend parallel to one another.

In an advantageous manner, the corrugation extends at least up to an end of the plate. In a particularly preferred embodiment, the corrugation extends over the entire length of the plate.

In a preferred manner, the corrugation is closed on at least one of its ends, The corrugation can comprise a corrugation outlet on each of its ends. The corrugation outlet is formed, in a preferred manner, by a plate blank which is arranged in the indentation forming the corrugation. In a particularly preferred manner, the plate blank is connected to the plate in a substance-to-substance bond, in particular as a result of welding,

The plate blank according to the invention can comprise the most varied forms, depending on the realization of the corrugation Depending on the realization of the corrugation, the plate blanks comprise, for example, a triangular form. In a particularly preferred manner. the plate blank is realized in a parabolic manner. In particular, the plate blank can be in the form approximately of a Gaussian bell curve. As a result of this type of design, the outside dimension of the plate blank matches the form of the corrugation to the greatest possible extent. As a result, the plate blank can easily be welded into the corrugation. The plate blank can comprise a constant thickness, but can also become thinner toward one side.

In a preferred manner, the plate blank is arranged at an angle in the corrugation. It extends, in this case, in particular from the bottom of the corrugation up to the upper edge thereof, up to the plane of the plate. In a preferred manner, the angle between the plate blank and the plate is between 15° and 45°, in a particularly preferred manner is 30°. Advantageously, the plate blank is arranged in such a manner in the corrugation that it rests by way of at least one of its edges in a plane with the plate and, in addition, closes off in a flush manner with the edge of the plate. If plates realized in this manner are welded together in the boom structure by way of their edges, a continuous, planar welded edge is then present, as a result of which a high quality welded seam to a further plate or a closure plate of the boom segment can be produced.

It is also possible for the plate blank to be realized in a beveled manner. At least one portion of the plate blank, in this case, is in alignment with the plane of the web plate. Another portion of the plate blank forms the corrugation outlet which, in a preferred manner, is at a spacing from the edge of the web plate and consequently from a welded edge of the plate

In place of plate blanks for the closure of the corrugation, round or angular profiles, in a preferred manner hollow profiles, can also be welded-in. In a preferred manner, the profiles, in this case, are welded into an opening which is realized as a result of burning-out or punching-out the plate. These types of hollow profiles can be used, for example, as supporting arms for concrete delivery pipes which are to be mounted on the boom of the concrete pump. The profiles can extend transversely through the boom and connect the plates together. The opening can comprise the most varied forms. In a preferred manner, the opening is realized in a round or angular manner, in particular in a triangular or rectangular manner.

By boom segments having long lengths, they are frequently assembled by placing web plates one next to another and connecting them together by means of a welded seam. In order to ensure sufficient strength, the connections must be realized in a high-quality manner. As a result of the distance between the corrugation outlet and the welded edge, the welded seam can be produced in a simple and favorable manner or rather the error rate (lack of fusion) is reduced precisely in the root run. Expensive and time-consuming seam preparation is no longer necessary either. All in all, an optimum connection between the individual plates can consequently be achieved.

In a preferred manner, the plate comprises an elongated, in particular a rectangular form. However, it is also possible for it to be realized as a trapezium. In a preferred manner, a short side, i.e. an edge of the plate is realized in an angled manner. As a result of said design, the articulated boom can be realized offset at the end such that, with the articulated boom in the collapsed state, boom segments, which are arranged one behind another, rest side by side.

In addition, an object of the invention is a method for producing a boom segment of an articulated boom of a large manipulator. As a result of the method according to the invention, a box profile, or rather a U-shaped profile is generated as a result of an upper flange and/or a lower flange being welded to lateral web plates. The method is characterized in that a reinforcing deformation is introduced into at least one of the web plates prior to the welding to the upper flange and/or to the lower flange.

As a result of introducing the reinforcing deformation, an articulated boom with a high degree of strength can be produced in a cost-efficient and simple manner.

Ideally, the reinforcing deformation is a corrugation which extends substantially parallel to the longitudinal axis of the boom segment, as explained above.

In an advantageous manner, the corrugation is introduced over the entire length of the plate as a result of bottoming or beveling. The plate is transformed as a result of the controlled downward movement of the upper tool of the bottoming machine. Corrugations with different depths and forms are produced depending an how far into the die of the bottoming machine the punch is moved. If the machine comprises rear stops, the plates to be beveled can thus be positioned quickly and reproducibly in a precise manner on the die.

It is also possible for the corrugation to be produced as a result of deep drawing or rather pressing. The advantage of deep drawing is that, as a result, corrugations which are dosed in only one operating step, in a preferred manner with a corrugation outlet, can be produced. An additional operating step, where, as explained above, plate blanks are introduced into the corrugations in order to close the corrugations, can be omitted.

In a preferred manner, prior to or after introducing the deformation, a recess which generates the corrugation outlet is added on at least one edge of the plate. The recess can be produced, for example, as a result of punching. Ideally, the recess comprises an approximately semicircular design.

To form the corrugation outlet, a plate blank, which is adapted to the inside contour of the corrugation, can be mounted by way of the plate in a preferred manner in a positive locking manner, in particular by means of welding, in the indentation forming the corrugation. Ideally, the plate blank is arranged in such a manner in the indentation forming the corrugation that the angle between the plate blank and the plate in a preferred manner is between 15° and 45°, in a particularly preferred manner is 30°. The plate blank is arranged in the corrugation in a preferred manner such that it rests with at least one of its edges in a plane with the plate and, in addition, is closed off in a flush manner with the edge of the plate. if plates realized in this manner are welded by way of their edges, a continuous straight welded edge is then present, as a result of which a high-quality welded seam can be produced.

So that the plate blank closes off with a preferably straight welded edge of the plate, which extends transversely or at an angle to the longitudinal axis of the boom segment, the plate blank can be post-machined. The desired straight welded edge can be obtained in this manner.

The invention and the technical environment are explained in more detail below by way of the figures. It must be pointed out that the figures show a particularly preferred realization variant of the invention. The invention, however, is not restricted to the realization variant shown. In particular, insofar as it is technically sensible, the invention includes arbitrary combinations of the technical features which are stated in the claims or are described in the description as relevant to the invention.

The figures are as follows:

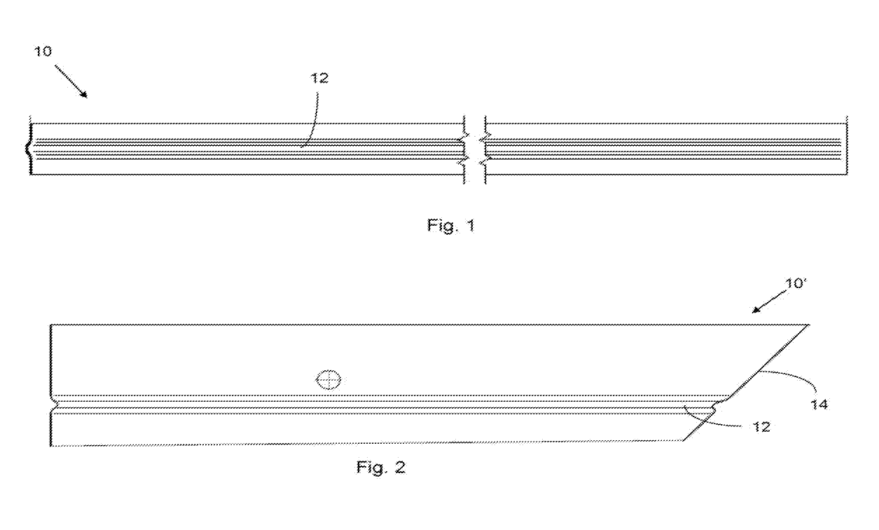

FIG. 1 shows a schematic top view of a first design of a plate according to the invention,

FIG. 2 shows a schematic top view of a second design of a plate according to the invention,

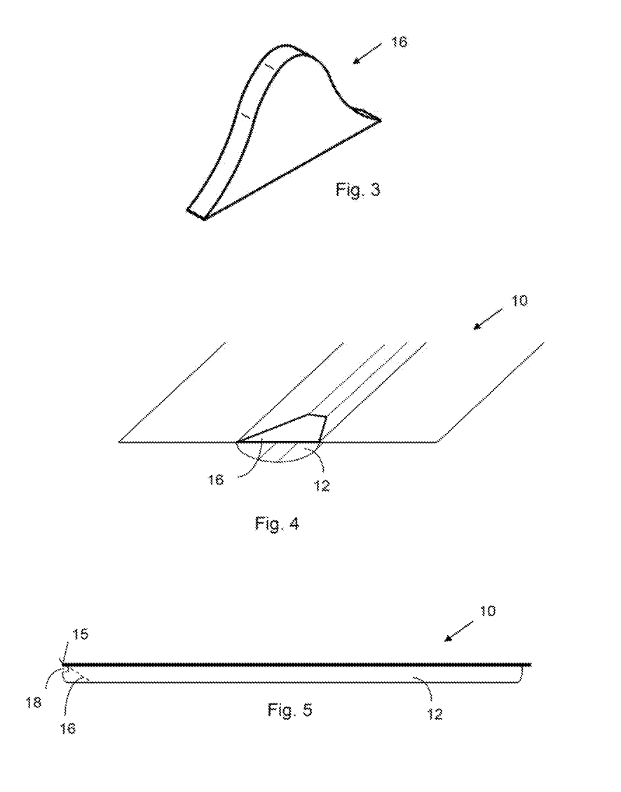

FIG. 3 shows a perspective view of a design form of a plate blank according to the invention,

FIG. 4 shows a perspective view of a further embodiment of a plate according to the invention,

FIG. 5 shows a schematic side view of a third design form of a plate according to the invention,

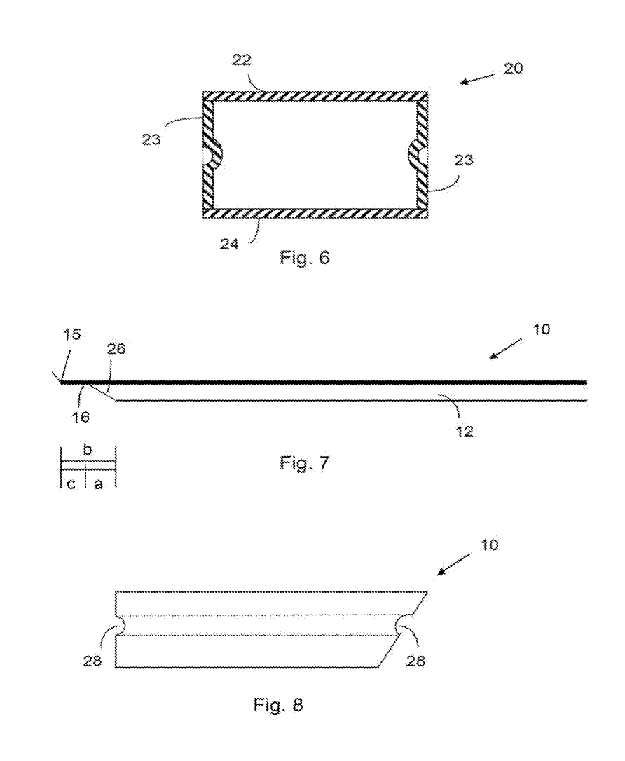

FIG. 6 shows a cross section of a design form of a boom segment according to the invention.

FIG. 7 shows a schematic side view of a fourth design form of a plate according to the invention,

FIG. 8 shows a schematic top view of a fifth design form of a plate according to the invention,

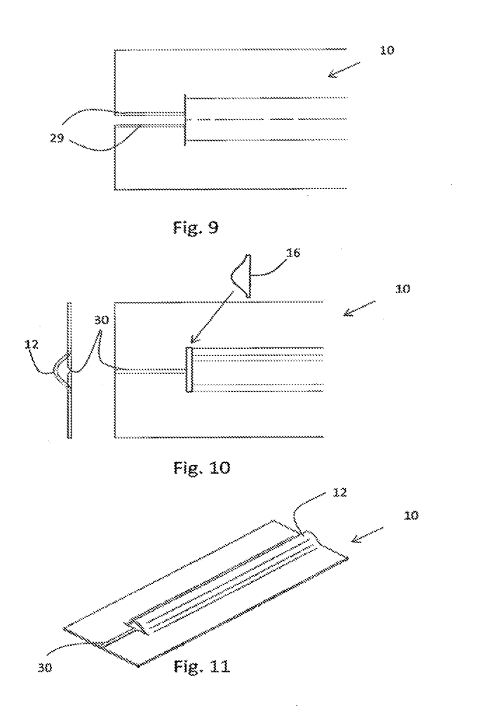

FIG. 9 shows a schematic top view of a sixth design form of a plate according to the invention prior to the beveling,

FIG. 10 shows a schematic top view of a sixth design form of a plate according to the invention after the beveling,

FIG. 11 shows a perspective view of a sixth design form of a plate according to the invention.

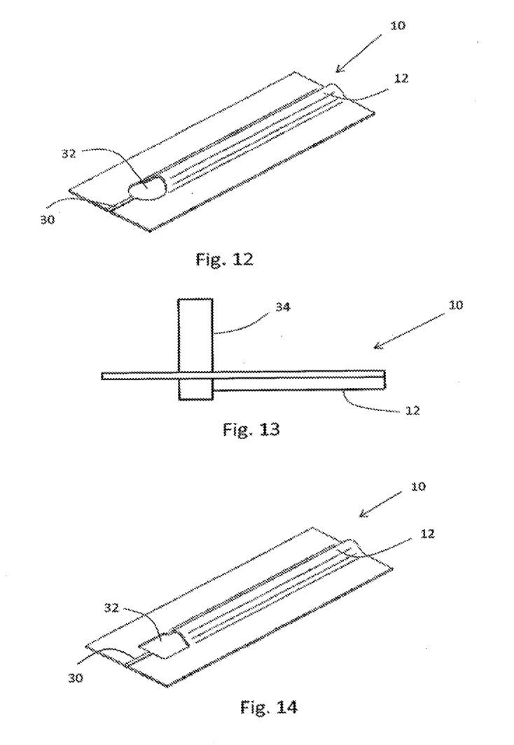

FIG. 12 shows a perspective view of a seventh design form of a plate according to the invention,

FIG. 13 shows a schematic side view of a seventh design form of a plate according to the invention,

FIG. 14 shows a perspective view of an eighth design form of a plate according to the invention,

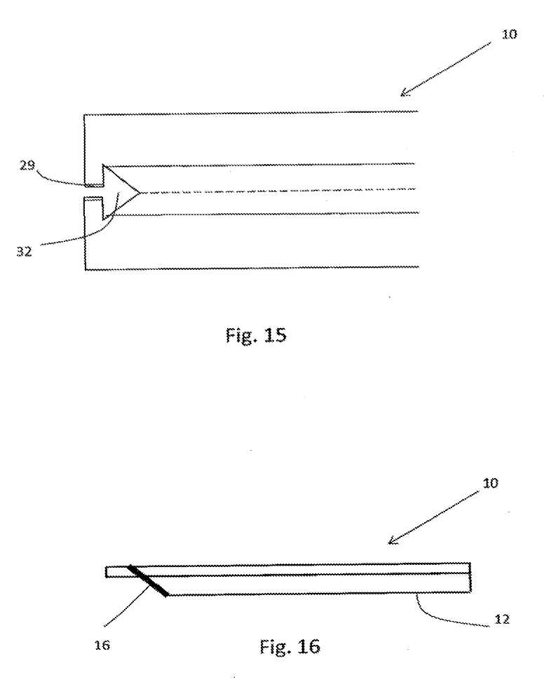

FIG. 15 shows a schematic top view of a ninth design form of a plate according to the invention,

FIG. 16 shows a schematic side view of the ninth design form of a plate according to the invention.

FIG. 1 shows a top view of a plate 10 according to the invention. The plate 10 is realized as an elongated, rectangular plate. A corrugation 12 extends in the longitudinal direction of the plate 10. The plate is reinforced per se by means of the corrugation 12. Due to the beveling radii, the reinforcement spans a large region and thus reduces the buckling field in a considerable manner. The plates 10 and consequently also the boom segments 20, which comprise the web plates according to the invention, have increased operational reliability compared to the boom segments known in the prior art.

The corrugation 12 can extend over the entire length of the plate 10. It is just as possible for the corrugation 12 only to extend over individual regions. As a result, the strength or rather the rigidity of the plate 10 can be individually adapted to the stress.

FIG. 2 shows a further embodiment of a plate 10′ according to the invention. The corrugation 12 is arranged eccentrically. The effectiveness of the corrugation 12 can be optimized in particular as a result of it comprising different forms and radii. The corrugation 12 can be realized in an advantageous manner as a semicircular corrugation, a box corrugation, a trapezoid corrugation or a triangular corrugation. The short side 14 of the plate 10 is realized at an angle in the case of the embodiment shown.

FIG. 3 shows a perspective view of a plate blank 16. In a preferred manner, the plate blank 16 is in the form of a Gaussian bell curve. As a result of such a design, the outside dimension of the plate blank 16 matches the form of the corrugation 12 to the greatest possible extent. As a result, the plate blank 16 can be welded quickly and simply onto the corrugation 12. However, the plate blank 16 can also comprise other forms. It can be realized in a trapezoidal or also parabolic manner. In a preferred manner, the plate blank 16 comprises a constant thickness.

FIG. 4 shows a perspective view of a further embodiment of a plate 10 according to the invention. The corrugation 12 reaches up to the edge 15 of the plate 10. A plate blank 16 is arranged at the end of the corrugation 12. The plate blank 16 is arranged at an angle inside the corrugation 12. It extends, in this case, in particular, from the bottom of the corrugation 12 up to the upper edge thereof. In an advantageous manner, the plate blank 16 is arranged in such a manner in the corrugation 12 that it lies by way of at least one of its edges in a plane with the plate 10 and, in addition, closes off in a flush manner with the edge 15 of the plate 10. If plates 10 realized in this manner are welded by way of their edges 15, a continuous planar welded edge is then present. A high quality welded seam can be produced as a result.

The plate blank 16 is fastened on the plate 10 or rather the corrugation 12 in a preferred manner in a substance-to-substance bond, in particular by means of a welded connection.

FIG. 5 shows a schematic side view of a further design of a plate 10 according to the invention. The corrugation 12 extends by way of at least one of its ends up to an edge 15 of the plate 10. At said end, the corrugation 12 comprises a recess 18 which extends parallel to the edge 15 of the plate 10. In order to obtain as long as possible a boom segment 20, several plates 10 are frequently arranged one behind another in a row. The connection between the individual plates is effected in a preferred manner by means of welding. As a result of the recess 18, a weld pool backing can be mounted on the edge of the plate 10. In a particularly preferred manner, the recess 18 directly adjoins the underside of the plate 10.

At the end of the plate 10 a plate blank 16 is additionally arranged at an angle in the corrugation 12. The angle between the plate blank 16 and the plate 10, in a preferred manner, is between 15° and 45°. Where the recess 18 is present, in a preferred manner the plate blank 16 is arranged in such a manner in the corrugation 12 that it does not project into the recess 18. Consequently, the weld pool backing is not impaired.

FIG. 6 shows a cross section of a design form of a boom segment 20 according to the invention. The boom segment 20 comprises a welded structure which is realized as a box profile. An upper flange 22 and a lower flange 24 are connected together by means of lateral web plates 23. The web plates 23 comprise reinforcing deformations in the form of the previously mentioned corrugations 12 which extend parallel to the longitudinal axis of the boom segment 20.

FIG. 7 shows a schematic side view of a fourth design form of a plate 10 according to the invention. The plate blank 16 is realized in a beveled manner. The plate blank 16 extends over the region b overall. In the region c, the plate blank 16 is in alignment with the plane of the plate 10. In the region a, the plate blank 16 forms the corrugation outlet 26. The corrugation outlet 26 is at a spacing from the edge 15 of the plate 10 and consequently also from a welded edge of the plate 10.

FIG. 8 shows a plate 10 according to the invention prior to introducing the deformation. The plate 10 comprises a recess 28 on each of its ends. The recess 28 is realized in such a manner that after the deformation of the plate 10 the corrugation 12 comprises a corrugation outlet. The recess 28 can be produced, for example, by means of punching-out or burning-out.

FIG. 9 shows a further embodiment of a plate 10 according to the invention prior to the beveling of the plate. The plate 10 is treated here such that the beveling does not extend over the entire length of the plate. Instead of which, two oppositely situated plate edges 29, which were spaced apart from one another prior to the beveling and after the beveling of the plate form a weld groove 30 which is shown in FIG. 10, remain at the end of the plate 10. The plate blank 16, in said embodiment, is welded perpendicularly to the plate 10 onto the end of the corrugation 12 which is formed by the beveling. The plate blank 16 can be welded into the inside of the corrugation 16, as shown in FIG. 10, or can be welded in front of the outer region of the corrugation 12 once the weld groove 30 has been closed by way of a welded seam.

FIG. 11 shows a perspective view of the plate 10 prior to the welding.

FIGS. 12 to 14 show further embodiments of the invention where, instead of the plate blank 16 for the closure of the corrugation 12, round (FIG. 12; FIG. 13) or angular (FIG. 14) hollow profiles 34, which are provided when the plate 10 is punched-out or burnt-out, are welded into an opening 32. Such types of hollow profiles can be used, for example, as supporting arms for concrete delivery pipes which are to be mounted on the boom of the concrete pump. The hollow profiles 34 can extend transversely through the boom and connect the plates 10 together. The weld groove 30, in the case of the embodiment shown here, extends longitudinally to the plate, however, it is also possible to cut the plate such that the weld groove 30 extends on one side transversely with respect to the plate edge in the region of the opening 32.

FIG. 15 and FIG. 16 show a further embodiment of the invention where a triangular or also semicircular cutout 32 is provided in conjunction with the plate edges 29 already shown in FIGS. 9-14. In the case of said embodiment, after the beveling of the plate 10, a plate blank 16 is welded onto or rather into the corrugation 12 in order to close the opening of the corrugation. The edges 29, after the beveling of the plate 10, once again form a weld groove 30 which is closed by way of a welded seam. The advantage of said exemplary embodiment compared to the exemplary embodiment according to FIG. 2 is that the plate blank 16 does not close off with the edge 15 of the plate and the edge 15 consequently has to be machined in a less expensive and time-consuming manner in order to produce a continuous, planar welded edge. Only an irregularity which is caused or is possibly caused by the welding of the welded seam 30 has to be machined in order to obtain a uniform welded edge.

It must be noted that the invention is applicable to the use of a reinforcing corrugation for the upper and lower flanges as well as for the web plates.

1-16. (canceled)

17. An articulated boom comprising:
a plurality of boom segments connected together via articulated joints,
wherein at least one of the boom segments includes a welded structure providing a box profile in which an upper flange and a lower flange arc connected together by lateral web plates, and
wherein at least one of the web plates, the upper flange, and the lower flange includes at least one reinforcing distortion.

18. The articulated boom of claim 17, wherein the reinforcing distortion is a channel-like indentation of the at least one of the web plates, the upper flange, and the lower flange which extends substantially parallel to the longitudinal axis of the boom segment.

19. The articulated boom of claim 17, wherein the reinforcing distortion is a corrugation which extends substantially parallel to the longitudinal axis of the boom segment.

20. The articulated boom of claim 19, wherein the corrugation divides the at least one of the web plates, the upper flange, and the lower flange at the ratio of between 1:5 and 1:1 when viewed in the direction transversely with. respect to the longitudinal axis of the boom segment.

21. The articulated boom of claim 19, wherein the corrugation is a semicircular corrugation, a box corrugation, a trapezoidal corrugation, or a trianguar corrugation.

22. The articulated boom of claim 19, wherein the corrugation is closed on at least one end.

23. The articulated boom of claim 19, further comprising a plate blank which is adapted to the inside contour of the corrugation and is welded to the at least one of the web plates, the upper flange, and the lower flange in the indentation which forms the corrugation.

24. The articulated boom of claim 23, wherein the plate blank encloses an acute angle of between 15 and 45° with a plane of the at least one of the web plates, the upper flange, and the lower flange.

25. The articulated boom of claim 23,
wherein the plate blank closes off in a flush manner with a welded edge of the at least one of the web plates, the upper flange, and the lower flange, and
wherein the welded edge extends transversely or at an angle with respect to the longitudinal axis of the boom segment.

26. The articulated boom of claim 23,
wherein the plate blank is beveled,
wherein at least one portion of the plate blank is in alignment with the plane of the at least one of the web plates, the upper flange, and the lower flange, and
wherein the plate blank forms a corrugation outlet at a spacing from the welded edge of the at least one of the web plates, the upper flange, and the lower flange.

27. The articulated boom of claim 17, wherein the articulated boom is for a mobile concrete pump.

28. A method for producing a boom segment of an articulated boom, the method comprising:
welding an upper flange and a lower flange to lateral web plates to generate a box profile; and
introducing a reinforcing deformation into at least one of the web plates, the upper flange, and the lower flange prior to the welding of the upper flange and the lower flange.

29. The method of claim 28, wherein the reinforcing deformation is a corrugation which extends substantially parallel to the longitudinal axis of the boom segment.

30. The method of claim 29, wherein the corrugation is introduced over the entire length of the at least one of the web plates, the upper flange, and the lower flange as a result of bottoming or beveling.

31. The method of claim 29, further comprising adding a recess providing a corrugation outlet to at least one edge of the at least one of the web plates, the upper flange, and the lower flange prior to or after introducing the deformation.

32. The method of claim 29, further comprising welding a plate blank, which is adapted to the inside contour of the corrugation to the at least one of the web plates, the upper flange, and the lower flange in an indentation which firms the corrugation to form a corrugation outlet.

33. The method of claim 32, further comprising:
machining the plate blank after welding the plate blank such that plate blank closes off in a flush manner with a welded edge of the at least one of the web plates, the upper flange, and the lower flange,
wherein the welded edge extends transversely or at an angle with respect to the longitudinal axis of the boom segment.

34. The method of claim 28, wherein the articulated boom is for a mobile concrete pump.

35. An articulated boom comprising:
a plurality of boom segments connected together via articulated joints,
wherein at least one of the boom segments includes a welded structure providing a box profile in which an upper flange and a lower flange are connected together by lateral web plates, and
wherein at least one of the web plates, the upper flange, and the lower flange includes a means for reinforcing the at least one of the web plates, the upper flange, and the lower flange.

36. The articulated boom of claim 35, wherein the articulated boom is for a mobile concrete pump.
